(19) United States
(12) Patent Application Publication
(10) Pub. No.: US 2010/0142435 A1
(43) Pub. Date: Jun. 10, 2010

(54) APPARATUS AND METHOD OF DATA TRANSMISSION AND RECEPTION USING MULTI-PATH

(76) Inventors: Jin-Kyeong Kim, Daejeon-city (KR); Hyoung-Jin Kwon, Chungcheongbuk-do (KR); Woo-Yong Lee, Daejeon-city (KR); Yong-Sun Kim, Gyeonggi-do (KR); Kyeougpyo Kim, Daejeon-city (KR); Jae-Sup Lee, Daejeon-city (KR); Min-Taig Kim, Daejeon-city (KR); Hwang Seung-ku, Chungcheongbuk-do (KR)

Correspondence Address: STAAS & HALSEY LLP, SUITE 700, 1201 NEW YORK AVENUE, N.W., WASHINGTON, DC, 20005, US

(21) Appl. No.: 12/602,919

(22) PCT Filed: Jun. 11, 2008
(86) PCT No.: PCT/KR2008/003245

§ 371 Date: Dec. 3, 2009

(30) Foreign Application Priority Data
Jun. 13, 2007 (KR) 10-2007-0058003
May 29, 2008 (KR) 10-2008-0050464

(51) Int. Cl. H04B 7/14

(52) U.S. Cl. 370/315

(57) ABSTRACT

Provided are a method and apparatus for transmitting/receiving data by using a multi-path. The multi-path is established between two transceivers, data is transmitted via each path at a predetermined time, a data receipt acknowledge control signal ACK of each path is received, and a path by which the data receipt acknowledge control signal ACK is not received is determined. Therefore, the path by which the data receipt acknowledge control signal ACK is not received is not used any further but data is transmitted via a path by which the data is previously transmitted, so that the data can be transmitted even if a line of sight (LOS) of the two transceivers comprising a directional antenna is blocked by a person or an obstacle.

### TECHNICAL FIELD

The present invention relates to a method and apparatus for transmitting and receiving data, and more particularly, to a method and apparatus for transmitting and receiving data according to a data receipt acknowledge control signal ACK for each path in a wireless communication system in a 60 GHz band for data transmission by using a directional antenna.

### BACKGROUND ART

With respect to channel characteristics, when a channel of a path that is being used in a wireless communication system in a 60 GHz band that uses a directional antenna, rather than an omni antenna, is blocked by a person or an obstacle, a channel status is extremely deteriorated, which causes a communication interrupt. In this case, although the communication interrupt can be resolved by removing the person or the obstacle, since the wireless communication system in the 60 GHz band exchanges data at a high speed of 3 Gbps, such channel blockage can cause a serious problem with the wireless communication system during a very short period of time.

Therefore, a method of exchanging data in spite of the person or the obstacle existing in a line of sight (LOS) of the wireless communication system in the 60 GHz band that uses the directional antenna is needed.

A method of transmitting a beam of the directional antenna via a line of reflection other than the LOS is used to overcome the obstacle. However, since a signal received via a non-line of sight (NLOS) instead of the LOS is reduced by more than 20 dB with respect to the channel characteristics, a transmitter requires a great amount of power, which increases power consumption.

### DETAILED DESCRIPTION OF THE INVENTION

### Technical Problem

The present invention provides a method and apparatus for exchanging data in spite of a person or an obstacle existing in a line of sight (LOS) of two transceivers having a directional antenna in a wireless communication system in a 60 GHz band that uses the directional antenna.

Other objectives and merits of the present invention will be understood by the description below and will be made clearer by describing embodiments of the present invention. It will be easily understood that the objective and merits of the present invention can be implemented by the means or a combination thereof recited in the claims.

### Technical Solution

The present invention can avoid an obstacle in millimeter radio wave communication. A device comprising a multi-directional antenna or a phase array antenna can use a multi-link in order to transmit data. The device receives a link based acknowledge signal from a peer device that uses a different link. The device can use a link if the acknowledge signal is received, whereas the device cannot use the link if not. For example, if the device uses two links all the time, and one link is blocked (the device does not receive a link based acknowledge signal), the device performs switching in order to use another link that is not blocked at any time. If the blocked link is released, the device uses the two links alternately.

### Best Mode

According to an aspect of the present invention, there is provided a method of transmitting data by using a multi-path including a direct path in a line of sight (LOS) and at least one relay path formed between a transmission end and a reception end by cross-selecting one or more available paths determined based on whether a data receipt acknowledge control signal is received from the multi-path.

According to another aspect of the present invention, there is provided a method of receiving data using a multi-path, comprising: receiving the data, which is cross-selected and transmitted, according to a previously established rule, from one or more available paths determined based on whether a data receipt acknowledge control signal is received among the multi-path including a direct path in an LOS and at least one relay path formed between a transmission end and a reception end; verifying the received data and extracting path information from the verified data; and generating a data receipt acknowledge control signal and transmitting the data receipt acknowledge control signal via a path included in the extracted path information.

According to another aspect of the present invention, there is provided a multi-path managing method used to transmit/receive data, the method comprising: preparing a list of one or more available paths among a multi-path including a direct path in an LOS and at least one relay path formed between a transmission end and a reception to end; deleting a path by which a data receipt acknowledge control signal with regard to transmitted data is not received among the one or more available paths that are cross-selected according to a previously established rule from an available path list, and registering the deleted path in a delete path list; and re-registering the deleted path in the available path list if the data receipt acknowledge control signal with regard to the data transmitted via the deleted path is received after a predetermined period of time passes.

According to another aspect of the present invention, there is provided an apparatus for transmitting data using multi-path including a direct path in an LOS and at least one relay path formed between a transmission end and a reception end by cross-selecting one or more available paths determined based on whether a data receipt acknowledge control signal is received from the multi-path.

According to another aspect of the present invention, there is provided an apparatus for receiving data by using a multi-path, the apparatus comprising: a data receiving unit receiving the data, which is cross-selected and transmitted, according to a previously established rule, from one or more available paths determined based on whether a data receipt acknowledge control signal is received among the multi-path including a direct path in an LOS and at least one relay path formed between a transmission end and a reception end; a data verifying unit verifying the received data and extracting path information from the verified data; and a data receipt acknowledge control signal generating unit generating a data receipt acknowledge control signal with regard to data that is transmitted via a path included in the extracted path information.

According to another aspect of the present invention, there is provided a computer readable recording medium having embodied thereon a computer program for executing the method of transmitting/receiving data by using a multi-path including a direct path in an LOS and the multi-path managing method used to transmit/receive data.

### Advantageous Effects

According to the present invention, a multi-path is established between two transceivers, data is transmitted via each path at a predetermined time, a data receipt acknowledge control signal ACK of each path is received, and a path by which the data receipt acknowledge control signal ACK is not received is determined. Therefore, the path by which the data receipt acknowledge control signal ACK is not received is not used any further but data is transmitted via a path by which the data was successfully transmitted, so that the data can be transmitted even if a line of sight (LOS) of the two transceivers comprising a directional antenna is blocked by a person or an obstacle.

Also, a path is dynamically managed by preparing a multi-path list, and deleting and re-entering the path according to whether the data receipt acknowledge control signal ACK is received, thereby flexibly dealing with the blockage of a specific path during data transmission.

### DESCRIPTION OF THE DRAWINGS

FIG. 1 is a diagram of data transmission/reception via two paths formed between two transceivers according to an embodiment of the present invention;

FIG. 2 is a diagram of data transmission/reception via a path formed by a relay device when a path in a line of sight (LOS) is blocked by a person or an obstacle according to an embodiment of the present invention;

FIG. 3 is a diagram for explaining a process of exchanging data that is transmitted/received, and data receipt acknowledge control signals in regard to a time axis according to an embodiment of the present invention;

FIG. 4 is a diagram for explaining a process of exchanging data that is transmitted/received, and data receipt acknowledge control signals when communication is blocked and resumes on a path in regard to a time axis according to an embodiment of the present invention;

FIGS. 5A and 5B are diagrams of the structure of a MAC data frame and a MAC data receipt acknowledge control frame, respectively, according to an embodiment of the present invention;

FIG. 5C is a diagram of a frame control field in a MAC header, and FIG. 5D is a table of link IDs of the frame control field according to an embodiment of the present invention;

FIG. 6 is a block diagram of a data transmitting/receiving apparatus that uses a multi-path selected according to a data receipt acknowledge control signal ACK of each path in a MAC layer according to an embodiment of the present invention;

FIG. 7 is a block diagram illustrating the functions of a path managing unit to according to an embodiment of the present invention;

FIG. 8A is a flowchart illustrating a method of transmitting/receiving data at a transmission end according to an embodiment of the present invention;

FIG. 8B is a flowchart illustrating a method of transmitting/receiving data at a reception end according to an embodiment of the present invention;

FIG. 9 is a flowchart illustrating a process of transmitting/receiving data using a data receipt acknowledge control signal of each path and managing paths according to an embodiment of the present invention; and

FIG. 10 is a diagram of a status transition process for managing available paths and transmitting data in a data transmission/reception apparatus that uses a multi-path according to an embodiment of the present invention.

### MODE OF THE INVENTION

Hereinafter, the present invention will be described more fully with reference to the accompanying drawings, in which exemplary embodiments of the invention are shown. Like reference numerals in the drawings denote like elements, and thus their description will be omitted. While describing the present invention, detailed descriptions about related well known functions or configurations that may blur the points of the present invention are omitted.

When a part “includes” an element, unless otherwise defined, another element is not excluded but is further included.

The present invention provides a method and apparatus for exchanging data in spite of a person or an obstacle existing in a line of sight (LOS) of two transceivers having a directional antenna in a wireless communication system in a 60 GHz band that uses the directional antenna rather than an omni antenna with respect to the channel characteristics.

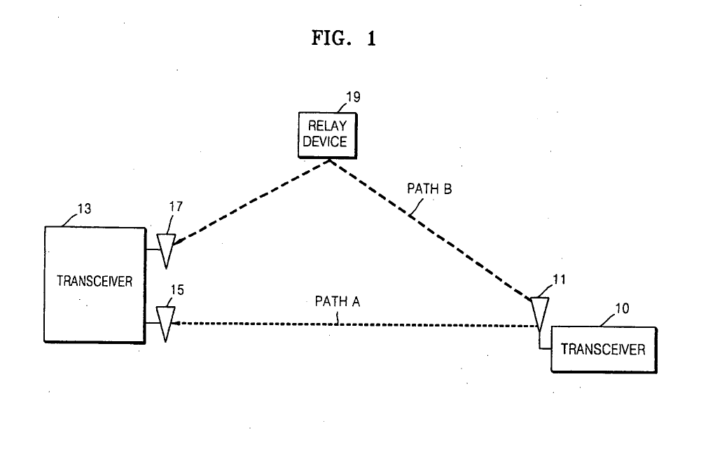

FIG. 1 is a diagram of data transmission/reception between two transceivers 10 and 13 via two paths A and B according to an embodiment of the present invention. Referring to FIG. 1, the transceivers 10 and 13 transmit/receive data via the path A (or a direct path) formed in a line of sight (LOS) and the path B (or a relay path) formed by a relay device 19.

A wireless communication system in a 60 GHz band generally exchanges data between the transceivers 10 and 13 via the path A over antennas 11 and 15 in the LOS of the transceivers 10 and 13. Meanwhile, in the present embodiment, a wireless communication system exchanges data between the transceivers 10 and 13 via the path A formed in the LOS and the additional path B by using the relay device 19 over antennas 11 and 17.

The relay device 19 is designed to avoid collisions between data transmitted/received via the additional path B formed by the relay device 19 and data transmitted/received via the path A formed in the LOS. The relay device 19 may comprise an active relay device capable of amplification and forwarding and a passive relay device formed of medium, such as a steel plate and capable of reflecting radio wave in the 60 GHz band. A detailed description of the operation of the relay device 19 will be omitted here.

The transceivers 10 and 13 can comprise a single antenna or two antennas, and the detailed description of the antenna will be omitted here. The antenna 15 of the path A and the antenna 17 of the path B may be identical to or different from each other.

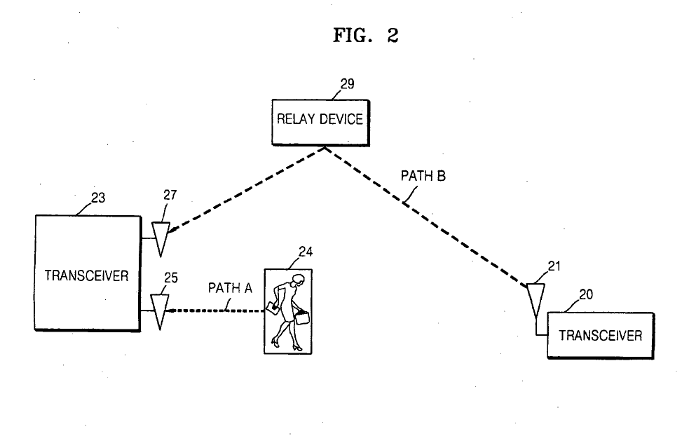

FIG. 2 is a diagram of data transmission/reception via a path B formed by a relay device 29 when a path A in an LOS is blocked by a person or an obstacle 24 according to an embodiment of the present invention. Referring to FIG. 2, a wireless communication system in a 60 GHz that uses a directional antenna generally stops exchanging data when the path A formed in the LOS by an antenna 21 of a transceiver 20 and an antenna 25 of a transceiver 23 is blocked by the person or the obstacle 24. However, a wireless communication system in the 60 GHz band of the present invention can exchange data via the path B formed by the relay device 29 and an antenna 27 when the path A formed in the LOS by the antenna 21 of the transceiver 20 and the antenna 25 of the transceiver 23 is blocked by the person or the obstacle 24. The antennas 25 and 27 may be identical to or different from each other.

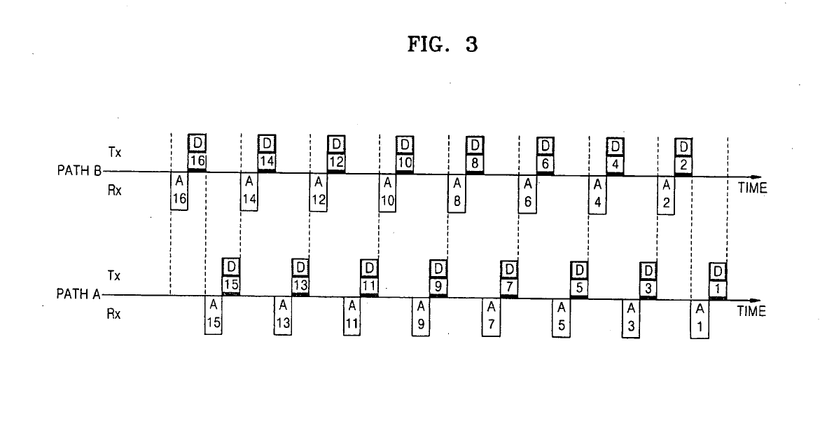

FIG. 3 is a diagram for explaining a process of exchanging data that is transmitted/received, and data receipt acknowledge control signals in regard to a time axis according to an embodiment of the present invention. Referring to FIG. 3, the data is alternately transmitted via a path A formed in an LOS and a path B formed by a relay device. Since the data exchange is not interrupted by a person or an obstacle as show in FIG. 2, the process of transmitting the data and receiving the data receipt acknowledge control signals is successfully performed.

The process is simplified by alternately using paths A and B, exchanging the data, and transmitting the data receipt acknowledge control signals every time the data is received. However, a method of using the paths A and B (for example, a transmission order, a transmission time, etc.) and a method of transmitting the data receipt acknowledge control signals (for example, whether to transmit the data receipt acknowledge control signals whenever the data is received or whether to transmit the data receipt acknowledge control signal once by collecting the data receipt acknowledge control signals with respect to a plurality of pieces of data) can be determined according to the system design and environment.

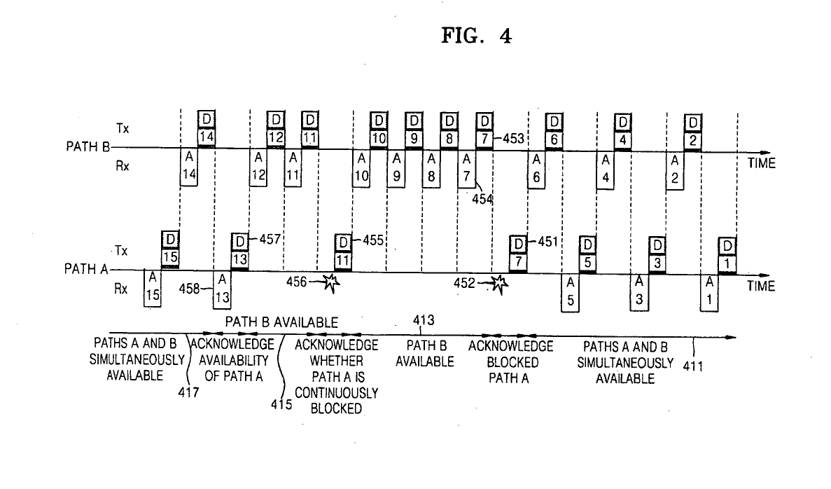

FIG. 4 is a diagram for explaining a process of exchanging data that is transmitted/received, and data receipt acknowledge control signals when communication is blocked and resumes on a path in regard to a time axis according to an embodiment of the present invention. Referring to FIG. 4, in a time section 411, a path A formed in an LOS and a path B formed by a relay device are alternately used to transmit the data when a person or an obstacle does not exist in the paths A and B.

When a data receipt acknowledge control signal 452 with regard to data D7 451 transmitted via the path A is not received, it is determined that the person or the obstacle suddenly appears in the path A, and thus the path A is blocked.

An MAC that recognizes that the path A is blocked transmits data D7 453 via the path B formed by the relay device and receives a data receipt acknowledge control signal 454 with respect to the data D7 453. In this case, the person or the obstacle does not exist in the path B formed by the relay device.

Thereafter, in an optional time section 413, the path A is not used but the path B is used to exchange the data.

Since the person or the obstacle that blocks the path A may not exist, data D11 455 is transmitted via the path A after a previously defined period of time passes.

When a data receipt acknowledge control signal 456 with regard to data D11 455 is not received, it is determined that the path A is still blocked and the data is exchanged via the path B in an optional time section 415. This process is optionally repeated.

After an optional period of time passes, when data D13 457 is transmitted via the path A and a data receipt acknowledge control signal Al 3 458 with regard to the data D13 457 is received, the data is transmitted via the paths A and B in an optional time to section 417.

Each optional time section can be previously determined according to whether a defined timer or a path delete count exceeds a threshold value.

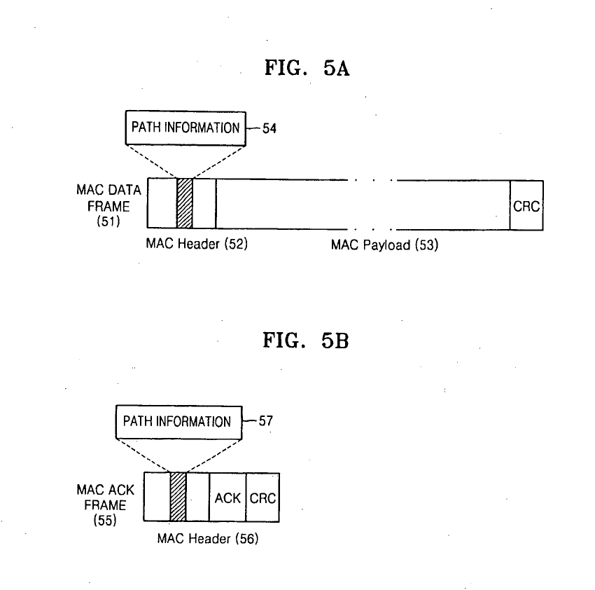

FIGS. 5A and 5B are diagrams of the structure of a MAC data frame 51 and a MAC data receipt acknowledge control frame 55, respectively, according to an embodiment of the present invention.

Referring to FIG. 5A, the MAC data frame 51 includes a MAC header 52 and a MAC payload 53. When information regarding the MAC header 52 includes path information 54 used to send data. A MAC that receives the MAC data frame 51 including the path information 54 can acknowledge a path by which data is transmitted, and generates the MAC data receipt acknowledge control frame 55 based on information of the path acknowledgement.

Referring to FIG. 5B, the MAC data receipt acknowledge control frame 55 transmits path information 57 extracted from received data through the MAC header 56.

The MAC that receives a MAC data receipt acknowledge control signal determines whether the received MAC data receipt acknowledge control signal regards the MAC data frame 51 sent by the MAC, and determines if the data is exchanged via a corresponding path. The MAC selects a path and exchanges the data based on the determination.

FIG. 5C is a diagram of a frame control field in a MAC header, and FIG. 5D is a table of link IDs of the frame control field according to an embodiment of the present invention.

Referring to FIGS. 5C and 5D, the frame control field can indicate information, such as a protocol version, secure, an ACK policy, a frame type, a frame subtype/delivery ID, a retry, and a link ID, in a predetermined bit. In the present embodiment, although 2 bits are allocated to the link ID field 59 from among a total of 16 bits, a different amount of bits can be allocated to the link ID field.

The link ID field is used to indicate a path (or a link) that is selected by a transmission frame in a relay operation that uses relay paths. Referring to FIG. 5D, the link ID field can indicate a path selected according to a bit value, i.e., a direct link or relay links 1, 2, and 3. The link ID field is used in the relay operation but can be disregarded in a normal operation that uses the direct path. Although the number of paths can be selected by a user, at least two paths are necessary for the relay operation.

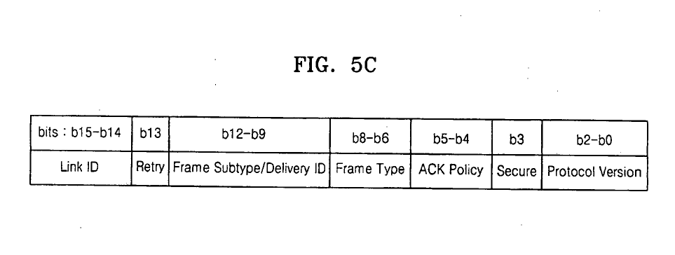

FIG. 6 is a block diagram of a data transmitting/receiving apparatus 600 that uses a multi-path selected according to a data receipt acknowledge control signal ACK of each path in a MAC layer according to an embodiment of the present invention. Referring to FIG. 6, the data transmitting/receiving apparatus 600 comprises a transmitting unit 610 and a receiving unit 650.

The transmitting unit 610 comprises a MAC data receiving unit 615, a path managing unit 620, a path inserting unit 625, and a MAC data transmitting unit 630.

The MAC data receiving unit 615 receives data that is to be transmitted from a MAC upper layer.

The path managing unit 620 prepares an available path list and manages a path list by registering and deleting paths.

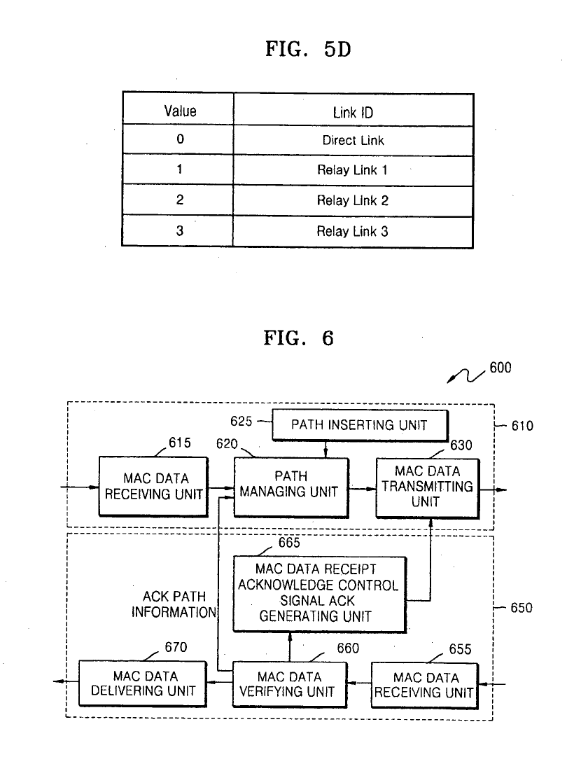

FIG. 7 is a block diagram illustrating the functions of the path managing unit 620 according to an embodiment of the present invention. Referring to FIG. 7, the path managing unit 620 performs functions of listing available paths 710, deleting paths and listing deleted paths 730, and registering deleted paths 750. The path managing unit 620 searches for a direct path in an LOS or a relay path using a relay device, selects candidate paths, transmits data using each candidate paths, and, if a data receipt acknowledge control signal is received from the receiving unit 650, registers a corresponding path in the available path list. The relay device that forms the relay path can be an active relay device capable of amplification and transmission or a passive relay device formed of a medium that reflects radio waves. When the path managing unit 620 does not receive a data receipt acknowledge control signal due to a person or an obstacle while cross-selecting paths included in the available path list according to a previously determined rule and transmitting data, the path managing unit 620 deletes a corresponding path from the available path list and registers the deleted path in a delete path list. The path managing unit 620 transmits data via the path that is registered in the delete path list due to the person or the obstacle and is no longer available after a previously determined period of time passes, receives a data receipt acknowledge control signal with regard to the data from the receiving unit 650, and adds (or registers) the deleted path to the available path list. A path that is unavailable when communication is blocked due to a person or an obstacle can be available when the communication is resume after a predetermined period of time passes. The predetermined period of time can be determined when a defined timer or a path delete count exceeds a threshold value, and can be determined by using other various methods.

The path inserting unit 625 selects a specific path from the available path list and inserts information of the selected path in a MAC header during data transmission. The data transmitting unit 630 can transmit the data via the selected specific path based on the information of the selected path. The information of the selected path indicates a relay path (one of a plurality of relay paths) or a direct path. The path inserting unit 625 can select the specific path according to a previously determined rule. Although the data is transmitted by cross-selecting the two paths A and B in FIGS. 3 and 4, it would have been obvious to one of ordinary skill in the art that two or more paths are selected to transmit the data or a single path is used to continuously transmit the data during a predetermined period of time.

The MAC data transmitting unit 630 delivers MAC data including the path information to a physical layer to transmit the MAC data via a determined path.

The receiving unit 650 comprises a MAC data receiving unit 655, a MAC data verifying unit 660, a MAC data receipt acknowledge control signal ACK generating unit 665, and a MAC data delivering unit 670.

The MAC data receiving unit 655 receives MAC data through the physical layer. The MAC data receiving unit 655 receives a MAC ACK regarding the data transmitted from the transmitting unit 610.

The MAC data verifying unit 660 determines whether the MAC data or the MAC ACK is exactly received. The MAC data verifying unit 660 extracts the path information from the MAC data or the MAC ACK when it is determined that the data is successfully transmitted. The MAC data verifying unit 660 transmits the path information of the MAC data to an ACK generating unit 665 and transmits the path information of the MAC ACK to the path managing unit 620 of the transmitting unit 610. The path managing unit 620 registers or re-registers an ACK receiving path in the available path list.

The ACK generating unit 665 generates a receipt acknowledge control signal ACK with regard to the MAC data when it is determined that the MAC data is accurately received through the MAC data verifying unit 660, and inserts the path information in a header of the receipt acknowledge control signal ACK. The ACK generating unit 665 delivers the receipt acknowledge control signal ACK to the MAC data transmitting unit 630 of the transmitting unit 610. The ACK generating unit 665 can generate the receipt acknowledge control signal ACK with regard to each piece of received data, or with regard to a plurality of pieces of received data by collecting two or more pieces of received data, and can transmit receipt acknowledge information to a transmission end.

The MAC data delivering unit 670 delivers the received MAC data to a MAC upper layer.

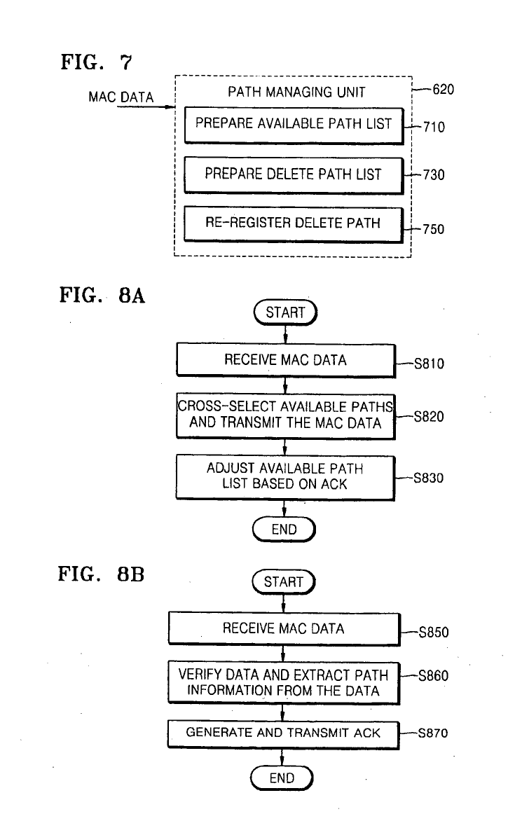

FIG. 8A is a flowchart illustrating a method of transmitting/receiving data at a transmission end according to an embodiment of the present invention. Referring to FIG. 8A, in the present embodiment, data is transmitted by cross-selecting one or more available paths that are determined based on whether a data receipt acknowledge control signal is received among a multi-path including a direct path in an LOS and at least one relay path that uses a relay device, formed between the transmission end and a reception end. The relay device that forms the relay path can be an active relay device capable of amplification and transmission, or a passive relay device formed of a medium that reflects radio waves.

In operation 810, the transmission end receives data that is to be transmitted from a MAC upper layer.

In operation 820, the data is transmitted by selecting an available path according to a previously determined rule. The data is transmitted using candidate paths determined by searching for the direct path in the LOS and the relay path that uses the relay device formed between the transmission end and the reception end according to the data that is to be transmitted, and, if a receipt acknowledge control signal is received from each candidate path, a corresponding path is registered in an available path list. It is assumed that the determined candidate paths are available paths and can be registered in an initial available path list. The data is transmitted by cross-selecting a path from the registered available paths according to the previously determined rule. Information of the selected path is inserted into a header of MAC data, and the data is transmitted to the selected path.

In operation 830, the transmission end determines if the receipt acknowledge control signal with regard to the transmitted data is received from the reception end and adjusts the available path list. A path for which the receipt acknowledge control signal is not received is deleted from the available path list and is inserted into a delete path list. The data is transmitted via the deleted path after a predetermined period of time passes, and, if the receipt acknowledge control signal with regard to the transmitted data is received, the deleted path is added to or re-registered in the available path list. The predetermined period of time can be determined according to whether a timer or a path delete count exceeds a threshold value.

FIG. 8B is a flowchart illustrating a method of transmitting/receiving data at a reception end according to an embodiment of the present invention. Referring to FIG. 8B, in operation 850, the reception end receives data transmitted via a cross-selected path according to a previously determined rule among one or more available paths that are determined based on whether a data receipt acknowledge control signal ACK is received from the transmission end. One or more available paths are included in a multi-path including a direct path in an LOS and at least one relay path that uses a relay device formed between the transmission end and the reception end.

In operation 860, the received data is verified and path information is detected from the verified data.

In operation 870, the data receipt acknowledge control signal ACK is generated, and the data receipt acknowledge control signal ACK is transmitted based on the detected path information. The detected path information can be included in a MAC header of the data receipt acknowledge control signal ACK. The data receipt acknowledge control signal ACK can be generated with regard to each piece of received data, or with regard to two or more pieces of received data.

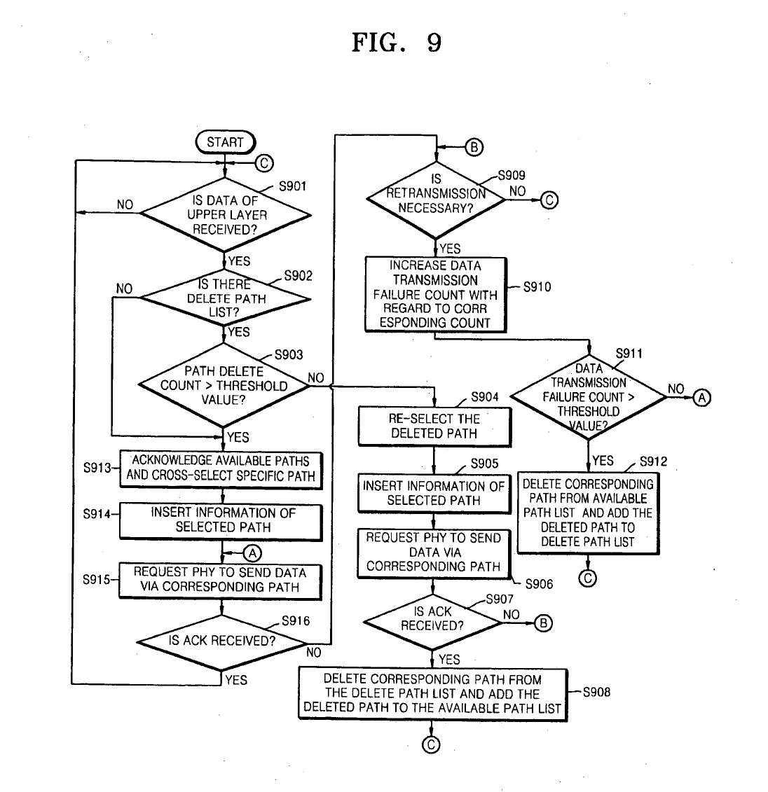

FIG. 9 is a flowchart illustrating a process of transmitting/receiving data using a data receipt acknowledge control signal ACK of each path and managing paths according to an embodiment of the present invention. Referring to FIGS. 9A and 9B, a data transmission/reception apparatus manages a path list including multi-path information, adjusts the path list according to whether the data receipt acknowledge control signal ACK of each path is received, multi-path is cross-selected, and data is transmitted, so that a data transmission failure caused by a blocked path can be overcome. The multi-path includes a direct path on an LOS and at least one relay path that uses a relay device.

In operation 901, the data transmission/reception apparatus continuously detects whether the data is received from a MAC upper layer.

When the data is received from the MAC upper layer, in operation 902, the data transmission/reception apparatus determines whether a deleted path is included in a to path list that is managed. The deleted path is registered in a delete path list.

When the deleted path is included in the path list, in operation 903, the data transmission/reception apparatus checks if an optional period of time passes after the path is deleted in order to determine whether the deleted path can be made available again. Whether the deleted path can be made available again depends on whether a blocked path is released, i.e., whether the data can be normally transmitted since a person or an obstacle no longer exists in the blocked path. Whether the optional period of time passes can be determined according to whether a path delete count exceeds a threshold value by driving a counter, or by using the timer. In the present embodiment, whether the optional period of time passes is determined according to whether the path delete count exceeds the threshold value.

When the path delete count exceeds the threshold value, in operation 904, the data transmission/reception apparatus re-selects the deleted path. In operation 905, the data transmission/reception apparatus inserts information about the deleted path into the MAC header. In operation 906, the data transmission/reception apparatus transmits the data to a PHY layer to request that the data be sent via a corresponding path.

In operation 907, the data transmission/reception apparatus determines whether the data receipt acknowledge control signal is received within a predetermined period of time in order to check if the sent data is normally transmitted.

When the data receipt acknowledge control signal is received within the predetermined period of time, in operation 908, the data transmission/reception apparatus removes the deleted path from the delete path list and re-registers the deleted path in the available path list. In operation 901, the data transmission/reception apparatus detects whether data is received from the MAC upper layer in order to transmit subsequent data.

When the data receipt acknowledge control signal is not received within the predetermined period of time, in operation 909, the data transmission/reception apparatus determines whether re-transmission of the data is required.

When re-transmission of the data is not required, the data transmission/reception apparatus proceeds with operation 901. When re-transmission of the data is required, in operation 910, the data transmission/reception apparatus increases a data transmission failure count with regard to a corresponding path. In operation 911, the data transmission/reception apparatus determines whether the data transmission failure count exceeds a previously defined threshold value.

When the data transmission failure count exceeds the previously defined threshold value, in operation 912, the data transmission/reception apparatus maintains the corresponding path in the delete path list, and proceeds with operation 901.

When the data transmission failure count does not exceed the previously defined threshold value, in operation 915, the data transmission/reception apparatus requests the PHY layer to send the data via the corresponding deleted path, and repeats a data re-transmission process.

In operation 903, when the path delete count does not exceed the threshold value, in operation 913, the data transmission/reception apparatus excludes the deleted path, checks the available paths, and cross-selects a specific path according to the previously determined rule.

In operation 914, the data transmission/reception apparatus inserts information of the selected path in the MAC header, and, in operation 915, requests the PHY layer to send the data via the corresponding path.

In operation 916, the data transmission/reception apparatus determines whether the data receipt acknowledge control signal is received within the predetermined period of time in order to check if the sent data is normally transmitted.

When data receipt acknowledge control signal is received, the data transmission/reception apparatus detects whether the data is received from the MAC upper layer in order to transmit next data in operation 901.

When the data receipt acknowledge control signal is not received, in operation 909, the data transmission/reception apparatus determines whether re-transmission of the data is required.

When re-transmission of the data is not required, the data transmission/reception apparatus proceeds with operation 901. However, when re-transmission of the data is required, the data transmission/reception apparatus proceeds with operation 910 and operations 911. When the data transmission failure count exceeds the previously defined threshold value, the data transmission/reception apparatus deletes a corresponding path from the available path list and adds the deleted path to the delete path list in operation 912, and proceeds with operation 901. When the data transmission failure count does not exceed the previously defined threshold value, the data transmission/reception apparatus proceeds with operation 915 and repeats a data re-transmission process.

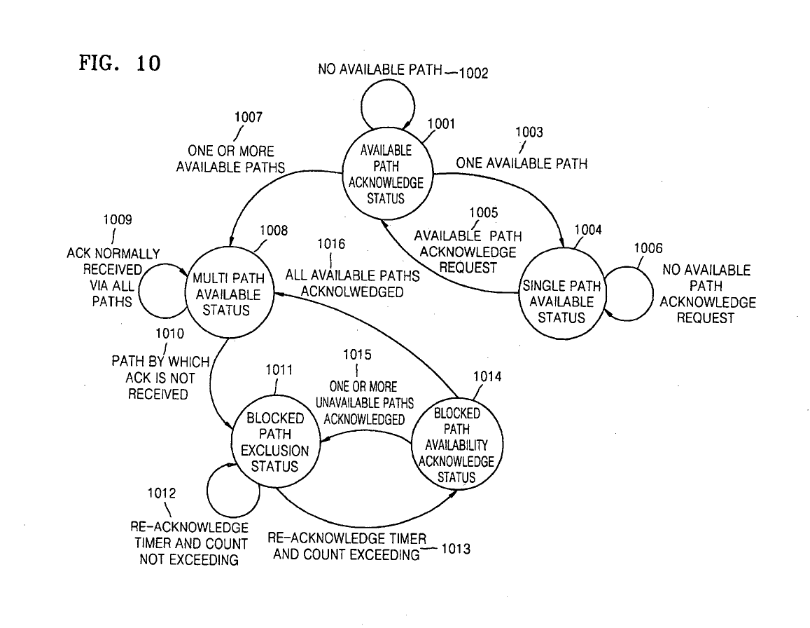

FIG. 10 is a diagram of a status transition process for managing available paths and transmitting data in a data transmission/reception apparatus that uses a multi-path according to an embodiment of the present invention. Referring to FIG. 10, a transmission end starts from an available path acknowledge status (1001) in which a counterpart device (a reception end) existing in an LOS and a relay device are acknowledged in order to manage available paths. In the available path acknowledge status, a MAC uses the reception end and the relay device to register available paths in an available path list.

When the reception end or the relay device does not exist, the available paths are continuously acknowledged (1002).

When the relay device does not exist or cannot be used, and one available path formed with the reception end exists (1003), the transmission end transits from the available path acknowledge status to a single path available status (1004) in which a single path is used to transmit data.

If the single path is no longer available due to a person or an obstacle in the single path available status, the transmission end requests the acknowledgement of the available paths (1005), and switches back to the available path acknowledge status (1001).

When the single path can be made continuously available and the acknowledgement of the available paths is not requested (1006), the transmission ends maintains the single path available status.

When a separate relay path that uses one or more relay devices is acknowledged, in addition to the path on the LOS of the reception end (1007), the transmission end switches from the available path acknowledge status to a multi-path available status (1008) in which all available paths are used to transmit data.

When a data receipt acknowledge control signal is received in all available paths in the multi-path available status (1009), the transmission ends maintains the multi-path available status.

When the data receipt acknowledge control signal is not received in a specific path (1010), the transmission end determines that the specific path is blocked by a person or an obstacle, deletes the blocked path from the available path list, and switches from the multi-path user status to a blocked path exclusion status (1011) in which data transmission is (temporarily) stopped along the blocked path.

Since the data transmission is not permanently stopped along the blocked path, the transmission end acknowledges if the blocked path can be made available again in the blocked path exclusion status. The transmission end drives an optionally defined re-acknowledge timer or a counter, examines the optionally defined re-acknowledge timer or the counter, when the optionally defined re-acknowledgement timer value or the count value does not exceed a threshold value (1012), maintains the blocked path exclusion status (1011), when the optionally defined re-acknowledgement timer value or the count value exceeds the threshold value (1013), and switches from the blocked path exclusion status to a blocked path availability acknowledge status (1014).

In the blocked path availability acknowledge status (1014), the transmission end determines whether the blocked path can be made available according to whether the data receipt acknowledge control signal is received after the data is sent via the blocked path. The transmission end switches back to the blocked path exclusion status (1011) when one blocked path is acknowledged, and switches back to the multi-path available status (1008) when all paths are available and no unavailable path exists (1016).

The present invention can be usefully applied to two transceivers comprising a directional antenna in a wireless communication system in a 60 GHz band that uses the directional antenna and also an omni antenna with respect to the channel characteristics. An example of the directional antenna of the present invention includes a phase array antenna capable of forming beam providing directional characteristics.

The present invention establishes one or more multi-paths including a relay path and a direct path in a line of sight (LOS), transmits data via each path every separately defined time period, and receives a data receipt acknowledge control signal ACK of each path. Therefore, the present invention stops using a path by which the data receipt acknowledge control signal ACK is not received, and transmits data a path by which the data receipt acknowledge control signal ACK is received, thereby solving a data transmission failure caused by a person or an obstacle in an LOS of two transceivers comprising a directional antenna.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, code and code segments for accomplishing the present invention can be easily construed by programmer skilled in the art to which the present invention pertains.

The terminology used herein is for the purpose of describing particular embodiments only and is not intended to be limiting of the invention.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of transmitting data by using a multi-path including a direct path in a line of sight (LOS) and at least one relay path formed between a transmission end and a reception end by cross-selecting one or more available paths determined based on whether a data receipt acknowledge control signal is received from the multi-path.

2. The method of claim 1, comprising:
transmitting data by cross-selecting the one or more available paths according to a previously established rule; and
adjusting the one or more available paths based on whether the data receipt acknowledge control signal with regard to the transmitted data is received.

3. The method of claim 2, wherein the transmitting of the data comprises:
searching for one or more available paths according to data that is to be transmitted, and registering one or more found available paths in a path list; and
transmitting the data by cross-selecting the registered one or more available paths.

4. The method of claim 2, wherein the adjusting of the one or more available paths comprises;
deleting a path by which the data receipt acknowledge control signal with regard to the transmitted data is not received from an available path list; and
re-registering the deleted path in the available path list if the data receipt acknowledge control signal with regard to the data transmitted via the deleted path is received after a predetermined period of time passes.

5. The method of claim 4, wherein whether the predetermined period of time passes is determined according to whether a timer or a path delete count exceeds a threshold value.

6. The method of claim 2, further comprising:
determining whether the one or more available paths include a deleted path before transmitting the data;
if the one or more available paths include the deleted path, determining whether a predetermined period of time passes after the path is deleted; and
transmitting the data via the deleted path in order to determine whether the deleted path can be available when the predetermined period of time passes.

7. The method of claim 2, further comprising:
determining if it is necessary to re-transmit the data transmitted via a path by which the data receipt acknowledge control signal is not received;
when it is necessary to re-transmit the data, determining whether a transmission failure count of the path by which the data receipt acknowledge control signal is not received exceeds a threshold value;
when the transmission failure count does not exceed the threshold value, re-transmitting the data via the path by which the data receipt acknowledge control signal is not received; and
when the transmission failure count exceeds the threshold value, re-transmitting the data via a path that is selected from paths excluding the path by which the data receipt acknowledge control signal is not received.

8. The method of claim 7, wherein, when the transmission failure count exceeds the threshold value, deleting the path by which the data receipt acknowledge control signal is not received from the available path list.

9. The method of claim 2, wherein an MAC header of the transmitted data includes path information.

10. The method of claim 1, wherein the relay path is formed by a relay device capable of amplification and transmission or a relay device formed of a radio wave reflecting medium.

11. The method of claim 1, wherein the method is applied to a wireless communication system that uses a directional antenna or a phase array antenna providing directional characteristics.

12. A method of receiving data using a multi-path, comprising:
receiving the data, which is cross-selected and transmitted, according to a previously established rule, from one or more available paths determined based on whether a data receipt acknowledge control signal is received among the multi-path including a direct path in an LOS and at least one relay path formed between a transmission end and a reception end;
verifying the received data and extracting path information from the verified data; and
generating a data receipt acknowledge control signal and transmitting the data receipt acknowledge control signal via a path included in the extracted path information.

13. The method of claim 12, wherein an MAC header of the data receipt acknowledge control signal includes the extracted path information.

14. The method of claim 12, wherein the data receipt acknowledge control signal is in regard to one or more pieces of the received data.

15. The method of claim 12, wherein the method is applied to a wireless communication system that uses a directional antenna or a phase array antenna providing directional characteristics.

16. A multi-path managing method used to transmit/receive data, the method comprising:
preparing a list of one or more available paths among a multi-path including a direct path in an LOS and at least one relay path formed between a transmission end and a reception end;
deleting a path by which a data receipt acknowledge control signal with regard to transmitted data is not received among the one or more available paths that are cross-selected according to a previously established rule from an available path list, and registering the deleted path in a delete path list; and
re-registering the deleted path in the available path list if the data receipt acknowledge control signal with regard to the data transmitted via the deleted path is received after a predetermined period of time passes.

17. The method of claim 16, wherein the preparing of the list of one or more available paths comprises:
selecting candidate paths by searching for one or more available paths according to data that is to be transmitted; and
registering a path by which the data receipt acknowledge control signal with regard to the data transmitted is received from among the candidate paths in the list of one or more available paths.

18. An apparatus for transmitting data using multi-path including a direct path in an LOS and at least one relay path formed between a transmission end and a reception end by cross-selecting one or more available paths determined based on whether a data receipt acknowledge control signal is received from the multi-path.

19. The apparatus of claim 18, comprising:
a data transmitting unit transmitting data by cross-selecting the one or more available paths according to a previously established rule; and
a path managing unit adjusting the one or more available paths based on whether the data receipt acknowledge control signal with regard to the transmitted data is received.

20. The apparatus of claim 19, wherein the path managing unit searches for one or more available paths according to data that is to be transmitted, registers one or more found available paths in a path list, deletes a path by which the data receipt acknowledge control signal with regard to the transmitted data is not received from an available path list, and re-registers the deleted path in the available path list if the data receipt acknowledge control signal with regard to the data transmitted via the deleted path is received after a predetermined period of time passes.

21. The apparatus of claim 20, wherein whether the predetermined period of time passes is determined according to whether a timer or a path delete count exceeds a threshold value.

22. The apparatus of claim 18, further comprising: a path information inserting unit inserting path information in an MAC header of the transmitted data.

23. The apparatus of claim 18, wherein the relay path is formed by a relay device capable of amplification and transmission or a relay device formed of a radio wave reflecting medium.

24. The apparatus of claim 18, wherein the apparatus is applied to a wireless communication system that uses a directional antenna or a phase array antenna providing directional characteristics.

25. An apparatus for receiving data by using a multi-path, the apparatus comprising:
a data receiving unit receiving the data, which is cross-selected and transmitted, according to a previously established rule, from one or more available paths determined based on whether a data receipt acknowledge control signal is received among the multi-path including a direct path in an LOS and at least one relay path formed between a transmission end and a reception end;
a data verifying unit verifying the received data and extracting path information from the verified data; and
a data receipt acknowledge control signal generating unit generating a data receipt acknowledge control signal with regard to data that is transmitted via a path included in the extracted path information.

26. The apparatus of claim 25, wherein the data receipt acknowledge control signal generating unit inserts the extracted path information in an MAC header of the data receipt acknowledge control signal.

27. The apparatus of claim 25, wherein the data receipt acknowledge control signal is in regard to one or more pieces of the received data.

28. The apparatus of claim 1, wherein the apparatus is applied to a wireless communication system that uses a directional antenna or a phase array antenna providing directional characteristics.
